(19) United States
(12) Patent Application Publication
(10) Pub. No.: US 2026/0259955 A1
(43) Pub. Date: Sep. 3, 2026

(54) SYSTEMS AND METHODS FOR VEHICLE PASSING PREDICTION

(71) Applicant: TOYOTA JIDOSHA KABUSHIKI KAISHA, Toyota-shi (JP)

(72) Inventors: Naoki NAGASAKA, Tokyo-to (JP); Daniele Molinari, Redwood City, CA (US)

(73) Assignee: TOYOTA JIDOSHA KABUSHIKI KAISHA, Toyota-shi (JP)

(21) Appl. No.: 19/068,081

(22) Filed: Mar. 3, 2025

(51) Int. Cl. G06F 17/40; G08G 1/01

(52) U.S. Cl. CPC G06F 17/40; G08G 1/0141

(57) ABSTRACT

Provided are a method, system, and device for predicting vehicle interactions. The method may include: selecting, from a driving log, a first vehicle and a second vehicle; determining, based on a sequence of a relative position between the first vehicle and the second vehicle on a given lane sequence from the driving log, whether a vehicle passing event occurred, wherein the vehicle passing event indicates that the first vehicle passes the second vehicle on the given lane sequence; and adding an annotation to the driving log based on determining whether the vehicle passing event occurred.

Example embodiments of the present disclosure relate to vehicle passing predictions.

### BACKGROUND

In the related art, autonomous (self-driving) vehicles may implement machine learning systems in order to provide predictions and decision-making for the self-driving vehicle. In this regard, a frequent determination an autonomous vehicle may need to make is whether or not a given first vehicle can pass a second vehicle, or whether the given first vehicle should stay behind the second vehicle.

The related art may be limited to only using interactions involving only a data collection vehicle itself in order to make decisions, whereas more safe and optimal decisions could be made if a dataset including data from other vehicles or other external sources is included. In addition, related art systems may only consider a more static state of vehicles in its decision-making (e.g., a vehicle is parked, or a vehicle is pulling over), without considering other factors.

Further, related art systems may not fully consider lane definitions while making annotations for vehicle training data. Accordingly, related art systems may make suboptimal decisions relative to the actual lane definitions and make erroneous or inaccurate decisions as to whether a vehicle is passing or not.

Accordingly, there is a need for a more robust and accurate system for making vehicle passing predictions and generating training data thereof.

### SUMMARY

Example embodiments consistent with the present disclosure provide a process for predicting vehicle interactions. The method may include: selecting, from a driving log, a first vehicle and a second vehicle; determining, based on a sequence of a relative position between the first vehicle and the second vehicle on a given lane sequence from the driving log, whether a vehicle passing event occurred, wherein the vehicle passing event indicates that the first vehicle passes the second vehicle on the given lane sequence; and adding an annotation to the driving log based on determining whether the vehicle passing event occurred.

It can be understood that example embodiments of the present disclosure allow for decision making to be based on relative position data and on a per lane sequence basis, such that the prediction can be more accurate and more robust, since it is not based on state definitions, position data can be provided externally aside from a data collection vehicle, and each possibility on a per lane sequence basis can be considered. Further, cost is reduced since humans do not need to label the data manually, as would be the case in the related art.

According to example embodiments, determining whether the vehicle passing event occurred may include comparing the relative position between the first vehicle and the second vehicle at two different instances in time to determine whether the first vehicle is following the second vehicle or the first vehicle is pulling away from the second vehicle. Determining whether the vehicle passing event occurred may be further based on a relative velocity between the first vehicle and the second vehicle.

Annotated driving logs may include a top-down view of the first vehicle, the second vehicle, and the given lane sequence. The annotation may include a pass label on the second vehicle based on determining the first vehicle passes the second vehicle on the given lane sequence, and the annotation may include a no-pass label on the second vehicle based on the first vehicle does not pass the second vehicle on the given lane sequence. The annotation may include a sequence of bounding boxes corresponding to the position of the first vehicle and the second vehicle, an outline of the given lane sequence, and road topology data.

According to example embodiments, the method may further include performing feature extraction on the annotated driving log to generate vehicle training data; training a machine learning model based on the generated vehicle training data; and deploying the trained machine learning model.

According to example embodiments, an apparatus may be provided. The apparatus may include: at least one memory storing computer-executable instructions; and at least one processor configured to execute the computer-executable instructions to: select, from a driving log, a first vehicle and a second vehicle; determine, based on a sequence of a relative position between the first vehicle and the second vehicle on a given lane sequence from the driving log, whether a vehicle passing event occurred, wherein the vehicle passing event indicates that the first vehicle passes the second vehicle on the given lane sequence; and add an annotation to the driving log based on determining whether the vehicle passing event occurred.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like reference numerals denote like elements, and wherein:

FIG. 1 illustrates an example of lane sequences according to one or more example embodiments;

FIG. 2 illustrates example vehicle passing scenarios, according to one or more example embodiments;

FIG. 3 illustrates an example deployed model for vehicle passing predictions, according to one or more example embodiments;

FIG. 4 illustrates an example query sequencing diagram for vehicle passing predictions, according to one or more example embodiments;

FIG. 5 illustrates an example method for predicting vehicle interactions, according to one or more example embodiments; and

FIG. 6 illustrates a diagram of an example components of a system that may be configured to implement one or more example embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “[A] and/or [B]”, “at least one of [A] and [B]” or “at least one of [A] or [B]” are to be understood as including only A, only B, or both A and B.

Expressions such as “at least one processor,” where configured to implement a plurality of operations, execute a plurality of instructions, etc., are to be understood as a single processor implementing the plurality of operations, etc., or each of plural processors implementing at least some (but not necessarily all) of the plurality of operations, etc.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Further, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Furthermore, the term “vehicle” described herein refers to any suitable type of vehicle in which example embodiments of the present disclosure can be implemented. For instance, the “vehicle” may refer to a motorized vehicle such as a car, a truck, a bus, a motorcycle, or any other suitable type of automobile powered by an engine, motor, or other mechanical means. Alternatively or additionally, the “vehicle” described herein may refer to a bicycle, a skateboard, and any other suitable types of non-motorized vehicle, without departing from the scope of the present disclosure.

According to example embodiments, a method for predicting vehicle interactions and providing annotated data based on the predictions may be provided, which may be used in training machine learning models. In particular, a method according to example embodiments may include selecting, from a driving log, a first vehicle and a second vehicle; determining, based on a sequence of a relative position between the first vehicle and the second vehicle on a given lane sequence from the driving log, whether a vehicle passing event occurred, wherein the vehicle passing event indicates that the first vehicle passes the second vehicle on the given lane sequence; and adding an annotation to the driving log based on determining whether the vehicle passing event occurred.

According to example embodiments, the system for making predictions may firstly receive a dataset outlining interactions between road users (which may include a vehicle, cyclist, pedestrian, etc.). This may generally be in the form of driving logs (e.g., from a fleet of data collection vehicles), although it should be appreciated that other forms of data may be used depending on the specific implementation.

Based on the received dataset, annotations may be automatically applied to the dataset based on determining whether or not a first given vehicle (an ego vehicle) will pass a second vehicle ahead of it on a given lane sequence, which is referred to as a “passing event”. Based on the ego vehicle passing the second vehicle, a “pass” or “no-pass” label may be applied as an annotation. The vehicles may be extracted from the dataset. The dataset may give the positional data of the vehicles over different points in time, that is, a sequence of their positional relationship. Determining whether or not the passing event occurred may be based on a set of rules. According to embodiments, this may be further based on the relative position of the two vehicles, and/or it may also include determining the relative velocity. Since the dataset may include future data after the potential passing event, the future data may be used in setting the rules for determining the passing event. The above process may be repeated for all road users (not just limited to vehicles, other road users such as cyclists, pedestrians may be included).

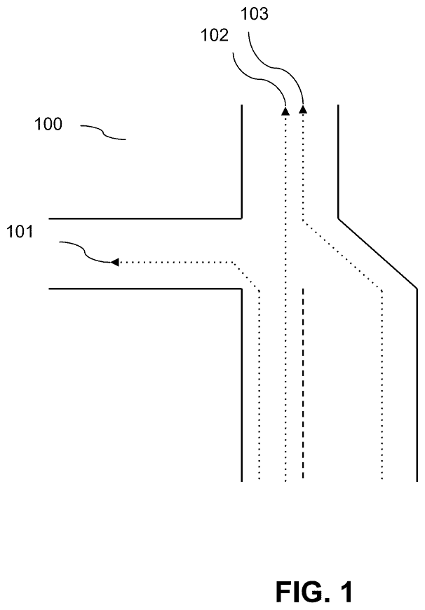

FIG. 1 illustrates an example of lane sequences according to one or more example embodiments. Road map 100 is provided, as viewed from above (e.g., bird's eye view). A lane division indicator is illustrated in the example, as well as a side road.

Each of the lane sequences 101, 102, and 103 may represent a unique sequence which can be traveled by a vehicle in a scenario. For instance, lane sequence 101 indicates that a vehicle is making a left turn on the left lane, lane sequence 102 is straight ahead on the left lane, and lane sequence 103 is following the right lane then switching to the left lane. It can be understood that a lane sequence may not necessarily be strictly defined based on a lane definition, the left lane and the right lane can each be used in multiple different lane sequences. Decision-making and predictions are made based on each lane sequence, that is, each lane sequence can be defined as a “query” lane, such that when considering a decision between two vehicles, it is considered (queried) uniquely on a per-lane sequence basis.

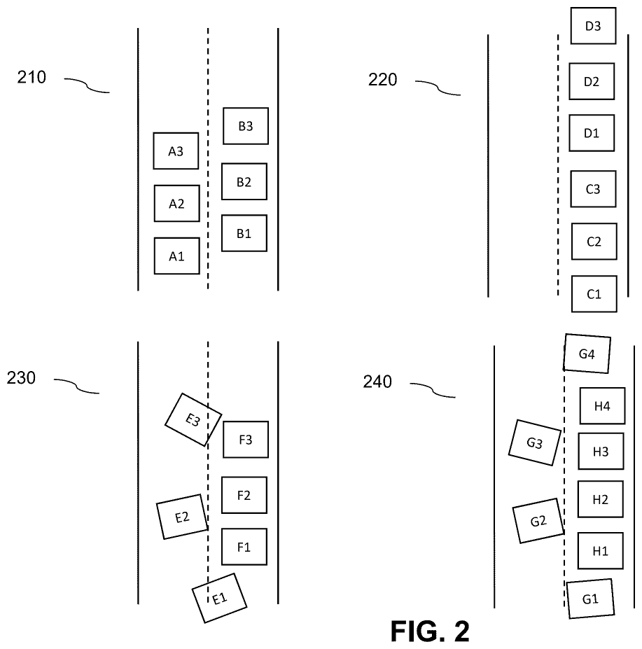

FIG. 2 illustrates example vehicle passing scenarios, according to one or more example embodiments. Each scenario illustrates the position of two different vehicles (e.g., vehicle A, vehicle B) at a given time frame (e.g., time 1, 2, 3). This is denoted by the vehicle label along with the time frame (e.g., A1 indicates vehicle A at time frame 1, and B2 indicates vehicle B at time frame 2, etc.). Scenarios 210, 220, 230, and 240 which may be considered when predicting passing events are illustrated. The lane sequence (query lane) defined in this instance is the right lane.

Scenario 210 illustrates vehicle A and vehicle B at times 1 through 3. The system may determine that there is no meaningful interaction, since both vehicles A and B are just cruising along side by side. Whether the vehicle A overtakes vehicle B is incidental and may be determined, for example, based on relative speed.

Scenario 220 illustrates vehicle C and vehicle D at times 1 through 3. There is a meaningful interaction between vehicle C and vehicle D, vehicle C is closely following vehicle D. Based on the relative position and relative velocity, vehicle D may be labeled as a “no-pass” obstacle.

Scenario 230 illustrates vehicle E and vehicle F at times 1 through 3. There is a meaningful interaction, and vehicle E may pass vehicle F. This may be determined based on the lateral position of vehicle E. Accordingly, vehicle F may be labeled as a “pass” obstacle.

Scenario 240 illustrates vehicle G and vehicle H at times 1 through 4. There is a meaningful interaction which is similar to scenario 230, however the relative position between vehicle G and vehicle H at time 1 is closer, such that the system may determine that vehicle G deviated to the left lane slightly in order to have enough clearance with vehicle H. In this case, the system may still label vehicle H as a “pass” obstacle, however it may attach an uncertainty value in view of the position of the vehicles.

Based on the annotations performed by labelling pass and no-pass in FIG. 2, a machine learning model may be trained by performing feature extraction in order for the user to generate model training data. Each vehicle or road user may have a defined bounding box (e.g., denoted by a first color) and the defined lane sequence may be highlighted (for example in a different color than the first color). Other map features may be included such as the road topology, in yet another color. The label for pass or no-pass may be provided. It should be appreciated that the specific configuration for how the machine learning data is generated may depend on the model and the specific implementation used.

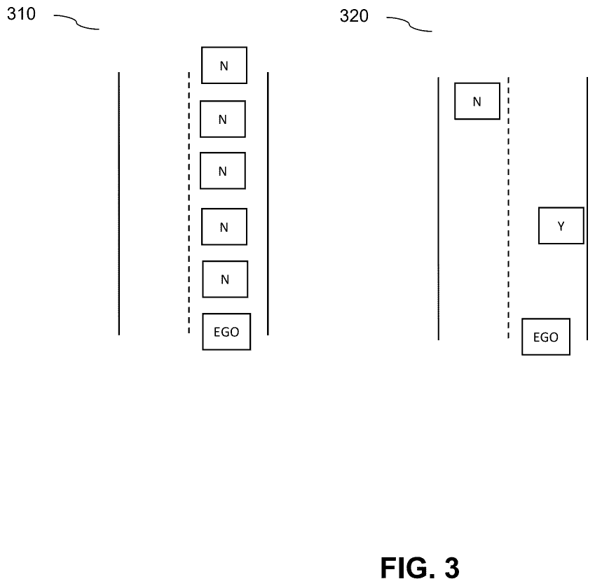

FIG. 3 illustrates an example deployed model for vehicle passing predictions, according to one or more example embodiments.

An example rendering for two cases, scenario 310 and scenario 320 are illustrated. Since the machine learning model has been trained based on the training data generated based on the annotated data above for predicting whether to pass or not, the ego vehicle (marked as “ego”) may determine whether to pass the vehicles in front of it.

In scenario 310 the lane sequence is too tightly close to the vehicles such that the relative position may make the model determine it as “no pass” (denoted as “N” in FIG. 3).

In scenario 320, the lane sequence has enough clearance such that the first closest vehicle relative to the ego vehicle may be marked as “pass” (denoted as “Y” in FIG. 3). For example, this may be since the model determines that the vehicle is close enough to the side of the road and/or stationary parked vehicle. On the other hand, a vehicle for example in the left lane would be marked as “no pass” (“N” similar to scenario 310 above). It should be appreciated that the training data may be augmented from that of the annotated data.

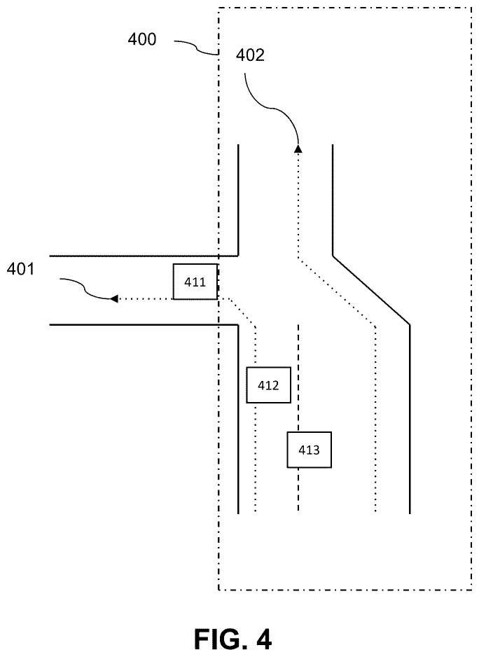

FIG. 4 illustrates an example query sequencing diagram for vehicle passing predictions, according to one or more example embodiments.

FIG. 4 exemplifies how a deployed machine learning model may determine all the possible queries (query lane sequences) prior to actually computing the result. A mission plan 400 may be used in order to limit the scope of which lanes and vehicles are considered. Object 411 is excluded based on the definition of the mission plan excluding it. Object 412 is considered, but only possible for query sequence lane 401 since its position only allows for it to interact with query sequence lane 401. Object 413 can be considered in both query sequence lanes 401 and 402, for example because it is far enough back that Object 413 can be considered in an overtake scenario in both lanes. Precomputing the queries may allow for the deployed model to more efficiently compute the result.

It can be understood from FIG. 1-4 above how the annotations made can be used to generate the vehicle training data and implement a ML model, particularly since feature extraction can be performed on the annotated driving log to generate the vehicle training data, training can be performed on the ML using said generated data, then the ML model can be deployed after training.

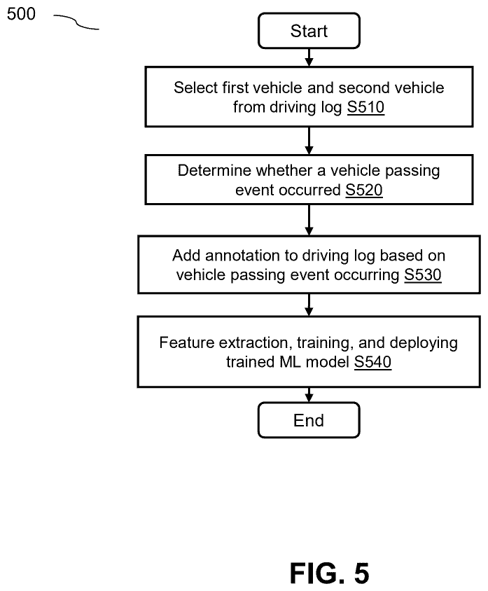

FIG. 5 illustrates an example method 500 for predicting vehicle interactions, according to one or more example embodiments.

Referring to FIG. 5, at operation S510, first vehicle and second vehicle may be selected from a driving log. The first vehicle, for example, may be an “ego vehicle” (e.g., a vehicle of interest), whereas the second vehicle may be, for example, a vehicle which the first vehicle intends to pass.

At operation S520, it may be determined whether a vehicle passing event occurred. This may be based on a sequence of relative positions between the first vehicle and the second vehicle on a given lane sequence from the driving log, wherein the vehicle passing event indicates that the first vehicle passes the second vehicle on the given lane sequence.

For instance, this may be based on comparing the relative position between the first vehicle and the second vehicle at two different instances in time, in order to determine whether the first vehicle is (a) following the second vehicle or (b) pulling away from the second vehicle.

This may also be further based on relative velocity between the first vehicle and second vehicle, which may either be calculated based on the relative positions, or provided via additional data in the driving log, for instance.

At operation S530, an annotation may be added to the driving log based on determining the vehicle passing event occurring. The annotated driving log may be a top-down (e.g., bird's eye view) of the first vehicle, the second vehicle, and the given lane sequence. For example, this may be in the form of visualized data, or recorded in a format such as a database or JSON/XML style document.

An annotation may comprise of either a “pass” label on the second vehicle based on determining the first vehicle passes the second vehicle on the given lane sequence, or a no-pass label based on determining the second vehicle is not passed by the first vehicle on the given lane sequence.

The annotations may further include a sequence of bounding boxes corresponding to the position of the first vehicle and the second vehicle, an outline of the given lane sequence, and road topology data.

At operation S540, feature extraction, model training, and deploying the trained ML model may be performed. In particular, feature extraction may be performed on the annotated driving log to generate vehicle training data. A machine learning (ML) model may be trained based on the generated vehicle training data, and subsequently once the model is trained, it may be deployed.

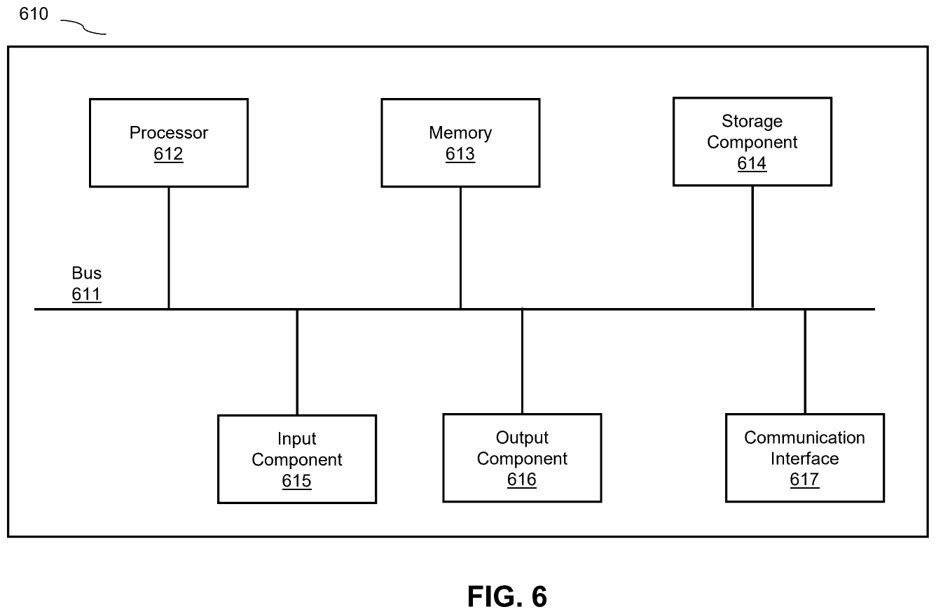

FIG. 6 illustrates a diagram of example components of a system, according to one or more example embodiments. As illustrated in FIG. 6, the system 610 may include at least one bus 611, at least one processor 612, at least one memory 613, at least one storage component 614, at least one input component 615, at least one output component 616, and at least one communication interface 617.

It is contemplated that the system 610 may include more or less components than illustrated in FIG. 6, without departing from the scope of the present disclosure. For instance, in some embodiments, the system 610 may include a plurality of storage components 614, the input component 615 and the output component 616 may be implemented as a transceiver component, the memory 613 and storage component 614 may be implemented as a memory storage, and the like.

The bus 611 may be configured to facilitate or enable communications among the components of the system 610. Specifically, the bus 611 may communicatively couple the components to each other and provide a means for data transfer and flow of control signals between the components. The bus 611 may include one or more of: an internal bus, an address bus, a data bus, a control bus, a controller area network (CAN) bus, an Ethernet bus, a peripheral component interconnect express (PCIe) bus, and any other suitable type of bus that can be implemented in the system 610 to enable communication and coordination between the components within the system 610 in real-time (or near real-time).

The processor 612 may be implemented in hardware, firmware, or a combination of hardware and software, and may be configured to handle real-time (or near real-time) data processing and control of the control system 610. The processor 612 may include one or more of: a central processing unit (CPU), a graphics processing unit (GPU), a neural processing unit (NPU), a tensor processing unit (TPU), an accelerated processing unit (APU), a microprocessor, a microcontroller, a digital signal processor (DSP), a field-programmable gate array (FPGA), an application-specific integrated circuit (ASIC), and/or another type of processing or computing component that can be implemented in the system 610. In some implementations, the processor 612 may be capable of being programmed to perform one or more operations described herein. Further, the processor 612 may include a plurality of processing units, each of which is dedicated to performing a specific operation.

The memory 613 may include one or more mediums for storing temporary data, runtime variables, program instructions, and buffers required for the operations of the control system 610. The memory 613 may include one or more of: a flash memory, a read-only memory (ROM), a random-access memory (RAM), a dynamic or static storage device (e.g., a flash memory, a magnetic memory, and/or an optical memory), any other suitable type of memory that can be implemented in the system 610 to store information and/or instructions for use by the processor 612.

The storage component 614 may be configured to store non-volatile data, such as firmware, configuration settings, calibration data, information, and/or software related to the operation and use of the system 610. For example, the storage component 614 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to embodiments, the storage component 614 may be configured to store computer-readable or computer-executable instructions for implementing one or more operations of the system 610. The storage component 614 may provide the stored information to the memory 613 for the execution of the processor 612.

The input component 615 may include one or more input components that permit the system 610 to receive information, such as via user input (e.g., a touch screen display, a keyboard, a keypad, a mouse, a button, a switch, and/or a microphone). The output component 616 may include one or more output components that provide output information from the system 610 (e.g., a display, a speaker, a navigation device, one or more light-emitting diodes (LEDs), etc.) According to embodiments, the input component 615 and/or the output component 616 may be optional and may be excluded from the system 610.

The at least one communication interface 617 may include a transceiver-like component (e.g., a transceiver and/or a separate receiver and transmitter) that enables the system 610 to communicate with other components (e.g., ECUs, user devices, etc.), such as via a wired connection, a wireless connection, or a combination of wired and wireless connections. For example, communication interface 617 may include a controller area network (CAN) bus interface, an Ethernet interface, an optical interface, a coaxial interface, an infrared interface, a radio frequency (RF) interface, a universal serial bus (USB) interface, a Wi-Fi interface, a cellular network interface, or the like.

According to one or more embodiments, the communication interface 617 may include at least one input/output (I/O) interface, at least one network interface, at least one storage interface, or the like, that enable the components 612-616 to communicate with other components. Further, the communication interface 617 may include one or more application programming interfaces (APIs) that allow the system 610 (or one or more components included therein) to communicate with one or more software applications (e.g., software application deployed in the ECUs, etc.)

Computer-executable instructions (e.g., software instructions, etc.) may be read into memory 613 and/or storage component 614 from another computer-readable medium or from another device (e.g., a remote server, an external storage, etc.) via, for example, the communication interface 617. When executed, the computer-executable instructions stored in memory 613 and/or storage component 614 may cause the processor 612 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

Based on the above, it can be understood that example embodiments of the present disclosure allow for decision making to be based on relative position data and on a per lane sequence basis, such that the prediction can be more accurate and more robust, since it is not based on state definitions, position data can be provided externally aside from a data collection vehicle, and each possibility on a per lane sequence basis can be considered. Further, cost is reduced since humans do not need to label the data manually, as would be the case in the related art.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of example embodiments of the present disclosure, as well as the associated technical advantages and significances, are provided in the following.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, as described hereinabove, one or more of the above components described above may be implemented as instructions stored on a computer readable medium and executable by at least one processor (and/or may include at least one processor). The computer-readable medium may include a computer-readable non-transitory storage medium (or media) having computer-readable program instructions thereon for causing a processor (or processors) to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a SoC, a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A method for predicting vehicle interactions, the method comprising:
selecting, from a driving log, a first vehicle and a second vehicle;
determining, based on a sequence of a relative position between the first vehicle and the second vehicle on a given lane sequence from the driving log, whether a vehicle passing event occurred, wherein the vehicle passing event indicates that the first vehicle passes the second vehicle on the given lane sequence; and
adding an annotation to the driving log based on determining whether the vehicle passing event occurred.

2. The method as claimed in claim 1, wherein determining whether the vehicle passing event occurred comprises:
comparing the relative position between the first vehicle and the second vehicle at two different instances in time to determine whether the first vehicle is following the second vehicle or the first vehicle is pulling away from the second vehicle.

3. The method as claimed in claim 2, wherein determining whether the vehicle passing event occurred is further based on a relative velocity between the first vehicle and the second vehicle.

4. The method as claimed in claim 1, wherein the annotated driving log comprises a top-down view of the first vehicle, the second vehicle, and the given lane sequence.

5. The method as claimed in claim 4, wherein the annotation comprises a pass label on the second vehicle based on determining the first vehicle passes the second vehicle on the given lane sequence, and the annotation comprises a no-pass label on the second vehicle based on determining the first vehicle does not pass the second vehicle on the given lane sequence.

6. The method as claimed in claim 5, wherein the annotation further comprises a sequence of bounding boxes corresponding to the position of the first vehicle and the second vehicle, an outline of the given lane sequence, and road topology data.

7. The method as claimed in claim 1, further comprising:
performing feature extraction on the annotated driving log to generate vehicle training data;
training a machine learning model based on the generated vehicle training data; and
deploying the trained machine learning model.

8. An apparatus for predicting vehicle interactions, the apparatus comprising:
at least one memory storing computer-executable instructions; and
at least one processor configured to execute the computer-executable instructions to:
select, from a driving log, a first vehicle and a second vehicle;
determine, based on a sequence of a relative position between the first vehicle and the second vehicle on a given lane sequence from the driving log, whether a vehicle passing event occurred, wherein the vehicle passing event indicates that the first vehicle passes the second vehicle on the given lane sequence; and
add an annotation to the driving log based on determining whether the vehicle passing event occurred.

9. The apparatus as claimed in claim 8, wherein the at least one processor is further configured to execute the computer-executable instructions to determine whether the vehicle passing event occurred by:
comparing the relative position between the first vehicle and the second vehicle at two different instances in time to determine whether the first vehicle is following the second vehicle or the first vehicle is pulling away from the second vehicle.

10. The apparatus as claimed in claim 9, wherein determining whether the vehicle passing event occurred is further based on a relative velocity between the first vehicle and the second vehicle.

11. The apparatus as claimed in claim 8, wherein the annotated driving log comprises a top-down view of the first vehicle, the second vehicle, and the given lane sequence.

12. The apparatus as claimed in claim 11, wherein the annotation comprises a pass label on the second vehicle based on determining the first vehicle passes the second vehicle on the given lane sequence, and the annotation comprises a no-pass label on the second vehicle based on determining the first vehicle does not pass the second vehicle on the given lane sequence.

13. The apparatus as claimed in claim 12, wherein the annotation further comprises a sequence of bounding boxes corresponding to the position of the first vehicle and the second vehicle, an outline of the given lane sequence, and road topology data.

14. The apparatus as claimed in claim 8, wherein the at least one processor is further configured to execute the computer-executable instructions to:
perform feature extraction on the annotated driving log to generate vehicle training data;
train a machine learning model based on the generated vehicle training data; and
deploy the trained machine learning model.

15. A non-transitory computer-readable recording medium having recorded thereon instructions executable by at least one processor to cause the processor to perform a method comprising:
selecting, from a driving log, a first vehicle and a second vehicle;
determining, based on a sequence of a relative position between the first vehicle and the second vehicle on a given lane sequence from the driving log, whether a vehicle passing event occurred, wherein the vehicle passing event indicates that the first vehicle passes the second vehicle on the given lane sequence; and
adding an annotation to the driving log based on determining whether the vehicle passing event occurred.

16. The non-transitory computer-readable recording medium as claimed in claim 15, wherein determining whether the vehicle passing event occurred comprises:
comparing the relative position between the first vehicle and the second vehicle at two different instances in time to determine whether the first vehicle is following the second vehicle or the first vehicle is pulling away from the second vehicle.

17. The non-transitory computer-readable recording medium as claimed in claim 16, wherein determining whether the vehicle passing event occurred is further based on a relative velocity between the first vehicle and the second vehicle.

18. The non-transitory computer-readable recording medium as claimed in claim 15, wherein the annotated driving log comprises a top-down view of the first vehicle, the second vehicle, and the given lane sequence.

19. The non-transitory computer-readable recording medium as claimed in claim 18, wherein the annotation comprises a pass label on the second vehicle based on determining the first vehicle passes the second vehicle on the given lane sequence, and the annotation comprises a no-pass label on the second vehicle based on determining the first vehicle does not pass the second vehicle on the given lane sequence.

20. The non-transitory computer-readable recording medium as claimed in claim 19, wherein the annotation further comprises a sequence of bounding boxes corresponding to the position of the first vehicle and the second vehicle, an outline of the given lane sequence, and road topology data.
